(19) United States
(12) Patent Application Publication
(10) Pub. No.: US 2025/0214669 A1
(43) Pub. Date: Jul. 3, 2025

(54) DROPPER SEATPOST CAPABLE OF ADJUSTING MAXIMUM UPWARD STROKE

(71) Applicant: J.D COMPONENTS CO., LTD., CHANG HUA HSIEN (TW)

(72) Inventor: Yu-An LIN, CHANG HUA HSIEN (TW)

(21) Appl. No.: 19/001,033

(22) Filed: Dec. 24, 2024

(30) Foreign Application Priority Data
Dec. 29, 2023 (TW) 112151662

(51) Int. Cl. B62J 1/08

(52) U.S. Cl. CPC B62J 1/08; B62J 2001/085

(57) ABSTRACT

A dropper seatpost includes an outer tube, an inner tube disposed movably upward and downward in the outer tube, and a pneumatic and hydraulic cylinder disposed in the outer tube. When the pneumatic and hydraulic cylinder is opened, the inner tube is moved upward and downward relative to the outer tube, and when the pneumatic and hydraulic cylinder is closed, the inner tube is unable to be moved upward and downward relative to the outer tube. A stroke adjustment assembly includes a floating piston and an oil guide pipe disposed in the inner tube and having a bottom end inserted into the pneumatic and hydraulic cylinder. When an oil is output from the oil guide pipe or flows back into the oil guide pipe, the floating piston is moved according to an oil volume, thereby adjusting a maximum upward stroke of the inner tube.

### BACKGROUND OF THE INVENTION

### 1. Field of the Invention

The present invention relates to dropper seatposts and more particularly, to a dropper seatpost that is capable of adjusting its maximum upward stroke.

### 2. Description of the Related Art

The height of a bicycle saddle significantly impacts the comfort and safety of the rider. Therefore, modern bicycles are often equipped with an adjustable seatpost, allowing the saddle height to be modified based on the rider's body size, riding habits, and environment. This adjustment ensures that the rider maintains the correct posture, improving both comfort and safety during the ride.

However, while the adjustable seatpost can lower the inner tube height to save storage space, it creates a potential inconvenience. After lowering the height of the inner tube, the rider must spend time readjusting the saddle to the appropriate height the next time the bike is used. This process caused inconvenience and frustration for the rider.

### SUMMARY OF THE INVENTION

It is one objective of the present invention to provide a dropper seatpost, which can adjust its maximum upward stroke according to actual needs.

To attain the above objective, the dropper seatpost of the present invention comprises an outer tube, an inner tube, a pneumatic and hydraulic cylinder, and a stroke adjustment assembly. The outer tube is disposed movably upward and downward in the outer tube, and the inner tube has a top end located outside the outer tube and a bottom end located inside the outer tube. The pneumatic and hydraulic cylinder is disposed in the outer tube for controlling a vertical movement of the inner tube relative to the outer tube, so that when the pneumatic and hydraulic cylinder is opened, the inner tube is allowed to be moved upward and downward relative to the outer tube, and when the pneumatic and hydraulic cylinder is closed, the inner tube is unable to be moved upward and downward relative to the outer tube. The stroke adjustment assembly includes a floating piston movably disposed in the pneumatic and hydraulic cylinder, and an oil guide pipe mounted in the inner tube and having a first guide end mounted to the top end of the inner tube, a second guide end inserted into the pneumatic and hydraulic cylinder, and a guide channel located between the first and second guide ends. When the pneumatic and hydraulic cylinder is closed, and an oil is output from the second guide end of the oil guide pipe or flows back into the oil guide pipe from the second oil end, the floating piston is moved according to an oil volume, thereby adjusting a maximum upward stroke of the inner tube.

It can be seen from the above that when adjusting the maximum upward stroke of the inner tube, first open the pneumatic and hydraulic cylinder and press down the inner tube to exceed its adjustable stroke, then close the pneumatic and hydraulic cylinder. Next, inject the oil through the first guide end of the oil guide pipe, allowing it to flow through the oil channel to the second guide end and output from the second guide end. At this point, the floating piston is moved according to the oil volume. Thereafter, reopen the pneumatic and hydraulic cylinder and release the inner tube. During the upward movement of the inner tube, it will be positioned according to the location of the floating piston, thus completing the adjustment of the maximum upward stroke of the inner tube.

Conversely, to restore the original upward stroke, first open the pneumatic and hydraulic cylinder and press down the inner tube to exceed its adjustable stroke, then close the pneumatic and hydraulic cylinder. Next, allow the oil to flow back from the second guide end of the oil guide pipe. At this point, the floating piston returns to its original position. Thereafter, reopen the pneumatic and hydraulic cylinder and release the inner tube. This completes the restoration of the maximum upward stroke of the inner tube.

Preferably, the pneumatic and hydraulic cylinder includes an outer cylinder, an inner cylinder disposed in the outer cylinder and spaced from the outer cylinder, and a top cover mounted on the top ends of the inner and outer cylinders. The second guide end of the oil guide pipe is penetrated through the top cover and located inside the inner cylinder. The floating piston is disposed between the top cover and the second guide end of the oil guide pipe. In this way, when the pneumatic and hydraulic cylinder is closed and the oil is output from the second guide end of the oil guide pipe, the floating piston is moved toward a direction away from the second guide end of the oil guide pipe. When the pneumatic and hydraulic cylinder is closed and the oil flows back into the oil guide pipe from the second oil end, the floating piston is moved toward the second guide end of the oil guide pipe.

Preferably, the top end of the inner tube has a first oil chamber and a second oil chamber communicating with the first oil chamber and axially communicating with the first guide end of the oil guide pipe.

Preferably, the top end of the inner tube has an adjustment threaded hole communicating with the first oil chamber. The stroke adjustment assembly further includes a knob screwed to the adjustment threaded hole for pushing the oil in the first oil chamber to the second oil chamber or allowing the oil in the second oil chamber to flow back into the first oil chamber.

Preferably, the inner tube has an adjustment hole axially passing through the top end and screwed to the first guide end of the oil guide pipe. The stroke adjustment assembly further includes an adjustment screw disposed in the guide channel and screwed to the first guide end of the oil guide pipe for pushing the oil from the oil channel to the second guide end or allowing the oil to flow back from the second guide end into the guide channel.

Preferably, the inner cylinder has an inner oil chamber. An air chamber is formed between the top cover, the inner cylinder, and the outer cylinder. The pneumatic and hydraulic cylinder further includes a bottom cover mounted to the bottom ends of the inner and outer cylinders and forming an outer oil chamber located below the air chamber with the inner and outer cylinders, and a control valve disposed in the inner cylinder and operable between an open position where the inner and outer oil chambers communicate with each other, so that the inner tube is allowed to be moved relative to the outer tube, and a close position where the inner and outer oil chambers do not communicate with each other, so that the inner tube is unable to be moved relative to the outer tube.

Preferably, the top end of the inner tube has a first oil chamber, a second oil chamber communicating with the first oil chamber, and a button hole communicating with the second oil chamber and the first guide end of the oil guide pipe. The stroke adjustment assembly further includes a piston, a button, and a return elastic member. The piston is movably disposed in the first oil chamber for pushing the oil in the first oil chamber into the second oil chamber or allowing the oil in the second oil chamber to flow back into the first oil chamber. The button is movably disposed in the button hole and movable between an initial position where the second oil chamber and the first guide end of the oil guide pipe do not communicate with each other by obstruction of the button, and a pressed position where the second oil chamber and the first guide end of the oil guide pipe communicate with each other through a communication hole of the button. The return elastic member acts on the button to keep it in the initial position.

To attain the above objective, the dropper seatpost of the present invention comprises an outer tube, an inner tube, a pneumatic and hydraulic cylinder, and a stroke adjustment assembly. The outer tube is disposed movably upward and downward in the outer tube, and the inner tube has a top end located outside the outer tube and a bottom end located inside the outer tube. The pneumatic and hydraulic cylinder is disposed in the outer tube for controlling a vertical movement of the inner tube relative to the outer tube, so that when the pneumatic and hydraulic cylinder is opened, the inner tube is allowed to be moved upward and downward relative to the outer tube, and when the pneumatic and hydraulic cylinder is closed, the inner tube is unable to be moved upward and downward relative to the outer tube. The stroke adjustment assembly includes a floating piston movably disposed in the pneumatic and hydraulic cylinder, and an oil guide pipe mounted in the inner tube and having a first guide end mounted to the top end of the inner tube, a second guide end inserted into the pneumatic and hydraulic cylinder, and a guide channel located between the first and second guide ends. When an oil is output from the second guide end of the oil guide pipe or flows back into the oil guide pipe from the second oil end, the floating piston is moved according to an oil volume, thereby adjusting a maximum upward stroke of the inner tube.

Additionally, the pneumatic and hydraulic cylinder includes an outer cylinder, an inner cylinder having an inner oil chamber and disposed in the outer cylinder and spaced from the outer cylinder, a top cover mounted on the top ends of the inner and outer cylinders and forming an air chamber with the inner and outer cylinders, a bottom cover mounted to the bottom ends of the inner and outer cylinders and forming an outer oil chamber located below the air chamber with the inner and outer cylinders, and a control valve disposed in the inner cylinder and operable between an open position where the inner and outer oil chambers communicate with each other, so that the inner tube is allowed to be moved relative to the outer tube, and a close position where the inner and outer oil chambers do not communicate with each other, so that the inner tube is unable to be moved relative to the outer tube. The second guide end of the oil guide pipe is penetrated through the top cover and located inside the inner cylinder. The floating piston is disposed between the inner and outer cylinders and separates the air chamber and the outer oil chamber. In this way, when the control valve is located at the open position and the oil is output from the second guide end of the oil guide pipe, the floating piston is moved toward a direction away from the bottom cover, and when the control valve is at the open position and the oil flows back into the oil guide pipe from the second oil end, the floating piston is moved toward the bottom cover.

Preferably, the floating piston is two in number. One of the floating pistons is disposed in the inner oil chamber and located between the second guide end of the oil guide pipe and the control valve to divide the inner oil chamber into an upper oil area and a lower oil area. The other of the floating pistons is disposed between the inner and outer cylinders to separate the air chamber and the outer oil chamber. In this way, when control valve is located at the open position and the oil flows back into the oil guide pipe from the second oil end, the floating piston in the inner oil chamber is moved toward the oil guide pipe and the floating piston between the inner and outer cylinders is moved toward the bottom cover.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a perspective view of a dropper seatpost of a first embodiment of the present invention.

FIG. 2 is a sectional view of the dropper seatpost of the first embodiment of the present invention.

FIG. 3 is an enlarged view of the dropper seatpost of the first embodiment of the present invention, showing the top end of the inner tube.

FIG. 4 is a sectional view taken along line 4-4 of FIG. 3.

FIG. 5 is an enlarged view of FIG. 2, showing that the valve stem is located at the close position.

FIG. 6 is an enlarged view of FIG. 2, showing that the second oil guide member is abutted against the floating piston.

FIG. 7 is a similar to FIG. 5, showing that the valve stem is located at the open position.

FIG. 8 is similar to FIG. 4, showing that the knob is moved inward.

FIG. 9 is similar to FIG. 6, showing that the oil chamber is formed between the floating piston and the second oil guide member.

FIG. 10 is similar to FIG. 2, showing that the maximum upward stroke of the inner tube is decreased.

FIG. 11 is a sectional view of the dropper seatpost of a second embodiment of the present invention.

FIG. 12 is an enlarged view of FIG. 11, showing the top end of the inner tube.

FIG. 13 is similar to FIG. 12, showing that the adjustment threaded screw is moved downward.

FIG. 14 is similar to FIG. 9, showing the oil chamber is formed between the floating piston and the second oil guide member.

FIG. 15 is similar to FIG. 11, showing that the maximum upward stroke of the inner tube is decreased.

FIG. 16 is a sectional view of the dropper seatpost of a third embodiment of the present invention.

FIG. 17 is an enlarged of FIG. 16, showing that the button is located at the initial position.

FIG. 18 is similar to FIG. 17, showing that the button is located at the pressed position and the piston is pushed inward.

FIG. 19 is similar to FIG. 18, showing that the button is located at the pressed position and the piston is pushed outward.

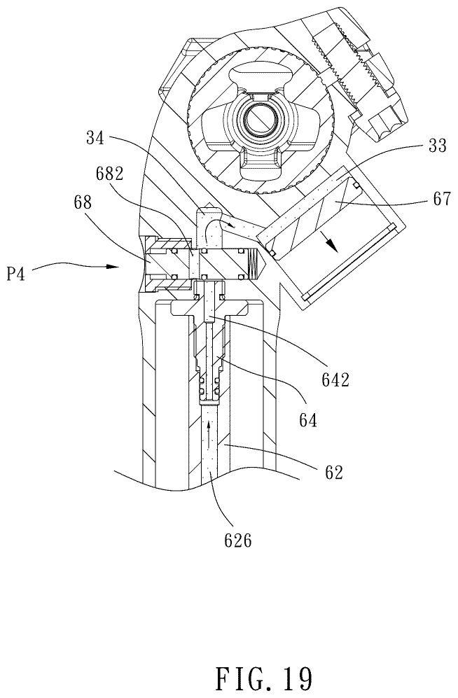

FIG. 20 is similar to FIG. 16, showing that the maximum upward stroke of the inner tube is decreased.

FIG. 21 is similar to FIG. 17, showing that the piston is equipped with a hexagonal hole and the knob is eliminated.

FIG. 22 is a sectional view of the dropper seatpost of a fourth embodiment of the present invention.

FIG. 23 is similar to FIG. 22, showing that the inner tube is pressed downward to force the outer floating piston to move upward.

FIG. 24 is a sectional view of the dropper seatpost of the fourth embodiment of the present invention, showing that the knob is moved outward.

FIG. 25 is similar to FIG. 23, showing that one of the floating pistons is moved upward and the other of the floating pistons is moved downward.

FIG. 26 is similar to FIG. 25, showing that the floating piston is lowered to rest against the bottom cover.

FIG. 27 is similar to FIG. 22, showing that the maximum upward stroke of the inner tube is decreased.

### DETAILED DESCRIPTION OF THE INVENTION

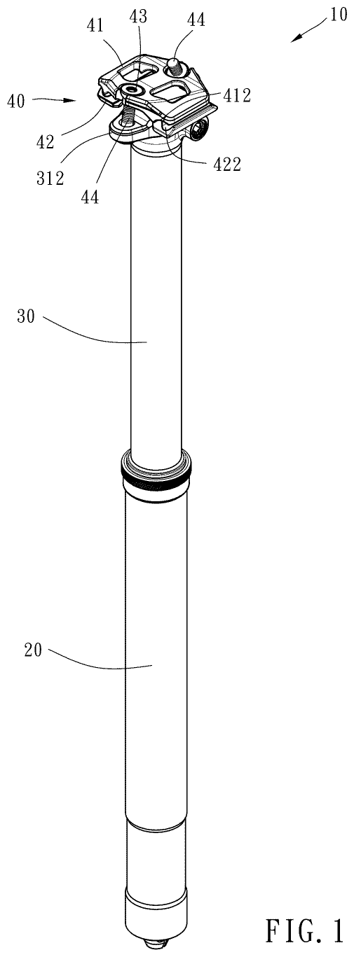

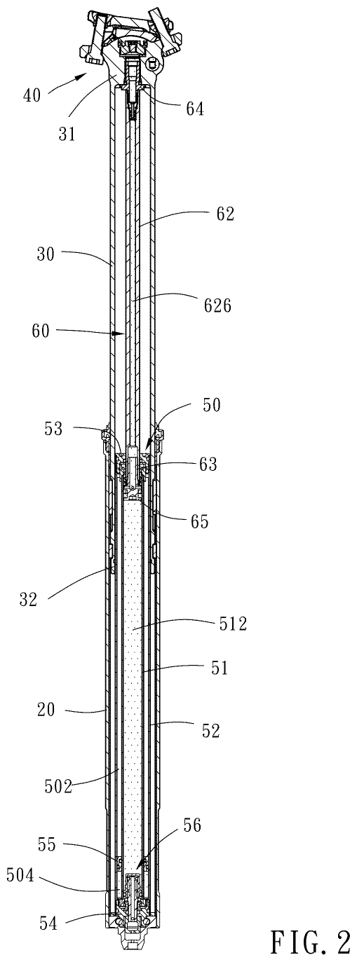

Referring to FIGS. 1 and 2, a dropper seatpost 10 of the first embodiment of the present invention comprises an outer tube 20, an inner tube 30, a saddle clamping device 40, a pneumatic and hydraulic cylinder 50, and a stroke adjustment assembly 60.

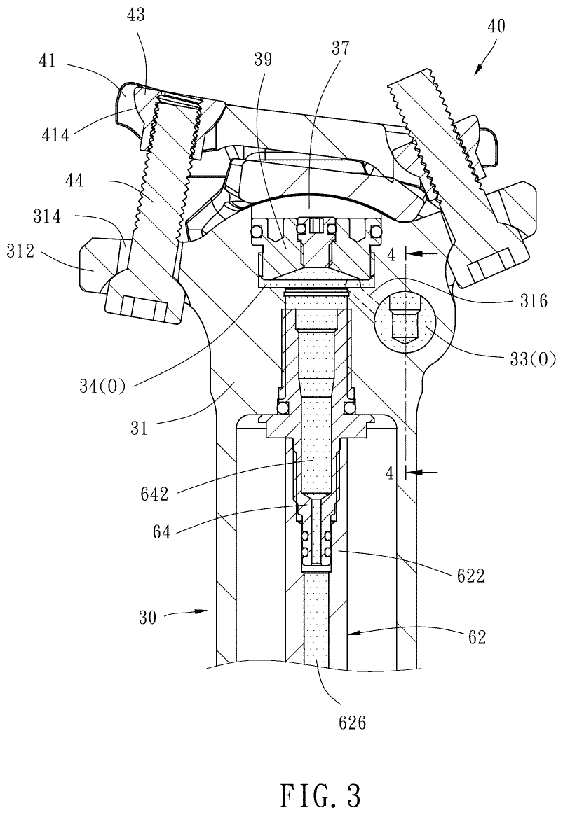

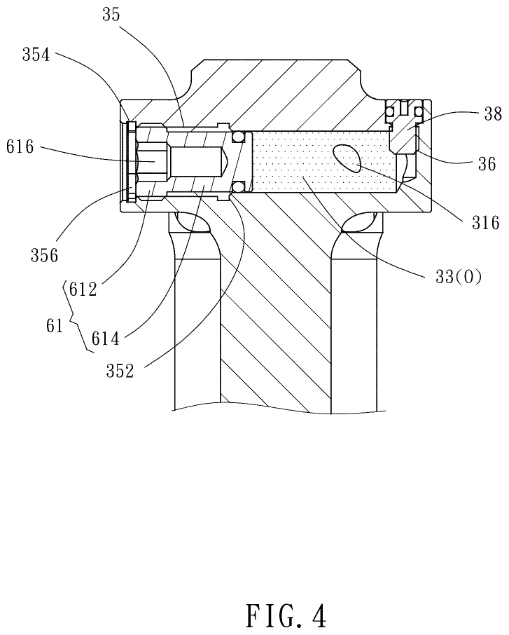

The inner tube 30 is inserted into the outer tube 20 from the top end of the outer tube 20. The inner tube 30 includes a top end 31 located outside the outer tube 20 and a bottom end 32 located inside the outer tube 20. The top end 31 of the inner tube 30 has two ear portions 312 each provided with a counterbored hole 314 (as shown in FIG. 3). Additionally, in this embodiment, the top end 31 of the inner tube 30 has a first oil chamber 33 and a second oil chamber 34. The first and second oil chambers 33, 34 are used for storage of an oil O. The first oil chamber 33 extends along a radial direction of the inner tube 30, and the second oil chamber 34 extends along an axial direction of the inner tube 30 and communicates with the first oil chamber 33 through a passage 316. As shown in FIGS. 3 and 4, the top end 31 of the inner tube 30 further has an adjustment threaded hole 35, an oil filling hole 36, and an oil replenishing hole 37. The adjustment threaded hole 35 axially communicates with one end of the first oil chamber 33 and has an outer annular groove 354 on its periphery wall for engagement of an outer stop ring 356. An inner stop portion 352 is formed between the adjustment threaded hole 35 and the first oil chamber 33. The oil filling hole 36 vertically communicates with the opposite end of the first oil chamber 33 and is closed by a screw 38. The oil replenishing hole 37 is provided at the top surface of the inner tube 30 and axially communicates with the second oil chamber 34. The oil replenishing hole 37 is covered by a plug 39.

The saddle clamping device 40 includes an upper clamping seat 41, a lower clamping seat 42, two nuts 43, and two bolts 44. As shown in FIGS. 1 and 3, two lateral sides of the upper clamping seat 41 each have an upper groove 412, and the other two lateral sides of the upper clamping seat 41 each have a nut hole 414. Two lateral sides of the lower clamping seat 42 each have a lower groove 422 corresponding to the upper clamping groove 412. The nuts 43 are disposed in the nut holes 414 of the upper clamping seat 41. The bolts 44 pass through the counterbored holes 314 from bottom to top and are screwed to the nuts 43. As such, after the assembly of the saddle clamping device 40 is completed, the oil replenishing hole 37 is covered. Additionally, the upper clamping grooves 412 and the lower clamping grooves 422 clamp two saddle bows (not shown) of a saddle (not shown), thereby completing the assembly with the saddle.

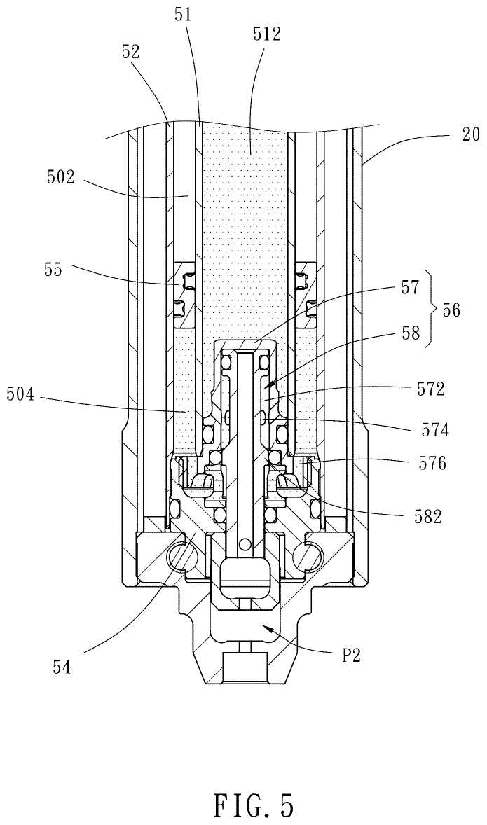

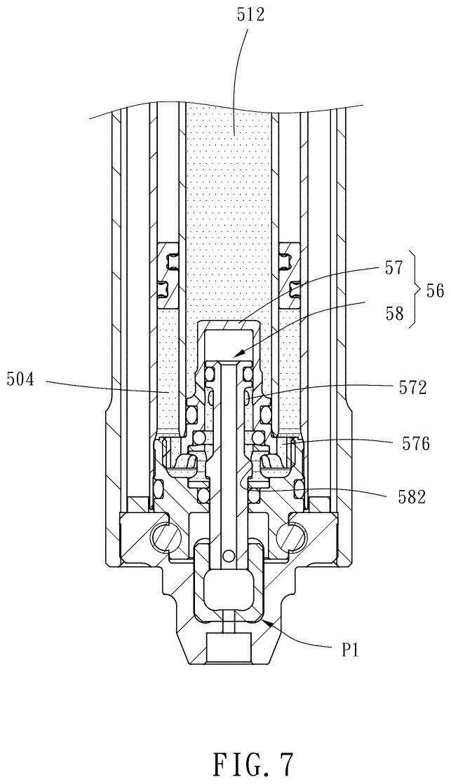

The pneumatic and hydraulic cylinder 50 includes an outer cylinder 51, an inner cylinder 52, a top cover 53, a bottom cover 54, and a control valve 56. As shown in FIGS. 2, 5, and 6, the inner cylinder 51 has an inner oil chamber 512, and the inner cylinder 51 is disposed in the outer cylinder 52 and spaced from the outer cylinder 52. The top cover 53 is mounted on the top ends of the inner and outer cylinders 51, 52 and forms an air chamber 502 with the inner and outer cylinders 51, 52. The bottom cover 54 is mounted on the bottom ends of the inner and outer cylinders 51, 52 and forms an outer chamber 504 with the inner and outer cylinders 51, 52. The air chamber 502 and the outer oil chamber 504 are separated by a floating piston 55. As shown in FIGS. 5 and 7, the control valve 57 includes a valve seat 57 and a valve stem 58. The valve seat 57 is mounted to the bottom cover 54 and located inside the inner cylinder 51, and the valve seat 57 has a valve hole 572, multiple upper oil guiding holes 574 communicating with the valve hole 572, and multiple lower oil guide holes 576 communicating with the valve hole 572. The valve stem 58 is disposed movably upward and downward in the valve hole 572 of the valve seat 57 and uses an outer flange 582 to control communication between the upper and lower oil guide holes 574, 576. When the valve stem 58 is located at an open position P1 (as shown in FIG. 7), the outer flange 582 of the valve stem 58 allows the upper and lower oil guide holes 574, 576 to be connected, so that the inner and outer oil chambers 512, 504 are connected to each other. At this point, the inner tube 30 is allowed to be moved upward and downward relative to the outer tube 20. When the valve stem 58 is located at a close position P2 (as shown in FIG. 5), the outer flange 582 of the valve stem 58 blocks between the upper and lower oil guide holes 574, 576, so that the inner and outer oil chambers 512, 504 are not connected to each other. At this point, the inner tube 30 is unable to be moved upward and downward relative to the outer tube 20. For further detailed structure and operation of the control valve 56, please refer to TW M616687 filed by the inventor.

The stroke adjustment assembly 60 includes a knob 61, an oil guide pipe 62, and a floating piston 63. As shown in FIG. 4, the knob 61 has a threaded head portion 612 screwed to the adjustment threaded hole 35 of the inner tube 30, and a body portion 614 connected with the threaded head portion 612 and inserted into the first oil chamber 33. Additionally, the knob 61 further has a hexagonal hole 616 recessed from the threaded head portion 612 toward the body portion 614 for engagement of a tool (such as a hex wrench, not shown). This ensures that when the knob 61 is driven by the aforementioned tool, it can be moved outward to rest against the outer stop ring 356 or inward to rest against the inner stop portion 352. As shown in FIGS. 2, 3, and 6, the oil guide pipe 62 is disposed in the inner tube 30, including a first guide end 622, a second guide end 624, and an oil channel 626 between the first and second guide ends 622, 624. The first guide end 622 is connected to a first oil guide member 64 screwed to the top end 31 of the inner tube 30 and provided with a first guide hole 642 communicating with the second oil chamber 34 and the guide channel 626. The second guide end 624 is penetrated through the top cover 53 and connected to a second oil guide member 65 located inside the inner cylinder 51 and provided with a plurality of second guide holes 652 communicating with the guide channel 626. In this embodiment, the floating piston 63 is disposed between the top cover 53 and the second oil guide member 65 and penetrated by the second guide end 624 of the oil guide pipe 62.

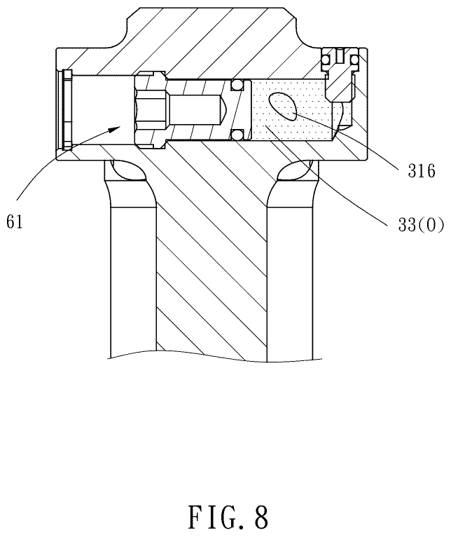

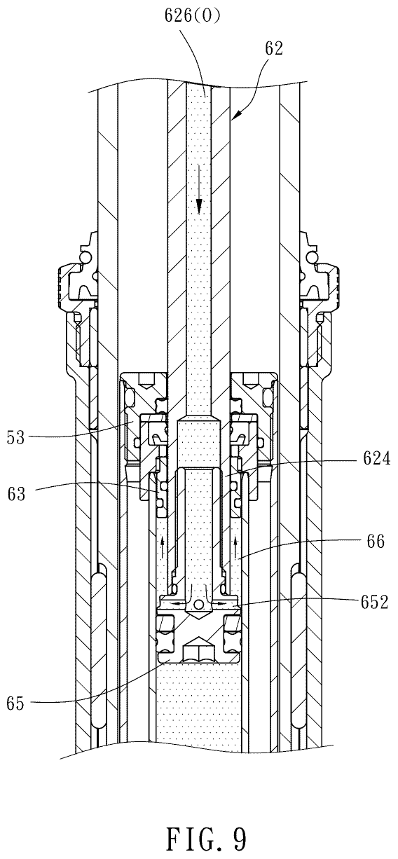

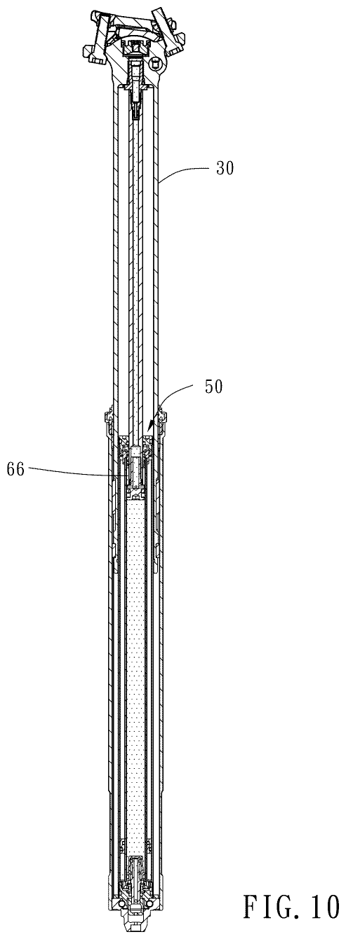

It can be seen from the above that when reducing a maximum upward stroke of the inner tube 30, first open the control valve 56 (as shown in FIG. 7) and press down the inner tube 30 to exceed its adjustable stroke, then close the control valve 56, temporarily positioning the inner tube 30. Next, rotate the knob 61 inward (as shown in FIG. 8), causing the oil O in the first oil chamber 33 to flow through the passage 316 into the second oil chamber 34. Then, the oil O flows from the second oil chamber 34 through the first guide hole 642 of the first oil guide member 64 into the oil channel 626 of the oil guide pipe 62 (as shown in FIG. 3). The oil O then flows through the oil channel 626 into the second guide holes 652 of the second oil guide member 65, and finally flows from the second guide holes 652 of the second oil guide member 65 into a third oil chamber 66 formed between the second guide end 624 of the oil guide pipe 62 and the floating piston 63 (as shown in FIG. 9). Thereafter, reopen the control valve 56 and release the inner tube 30. At this point, the inner tube 30 will automatically rise. During the upward movement, the oil O in the third oil chamber 66 pushes the floating piston 63 upward until the floating piston 63 comes into contact with the top cover 53, at which point the upward movement will stop. In this way, as shown in FIG. 10, the inner tube 30 is restricted by the third oil chamber 66 to complete the reduction of the maximum upward stroke.

After complete the reduction of the maximum upward stroke of the inner tube 30, if a rider lowers the height of the inner tube 30 to the minimum by using the pneumatic and hydraulic cylinder 50 after the ride, the next time the rider rides, simply opening the pneumatic and hydraulic cylinder 50 will cause the maximum upward stroke of the inner tube 30 to be limited by the third oil chamber 66, allowing the inner tube 30 to only rise to the height shown in FIG. 10. For the same rider, there will be no need to readjust the seat height, thus effectively saving operational time and increasing user convenience.

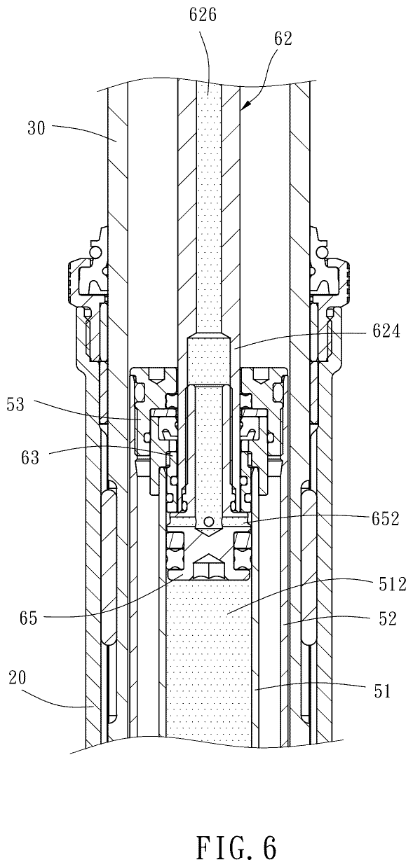

Conversely, to restore the original upward stroke, first open the control valve 56 and press down the inner tube 30 to exceed its adjustable stroke, then close the control valve 56. Next, rotate the knob 61 outward (as shown in FIG. 4), allowing the oil O in the second oil chamber 34 to flow back into the first oil chamber 33. Then, the oil O in the third oil chamber 66 flows through the second guide holes 652 of the second oil guide member 65 into the oil channel 626 of the oil guide pipe 62. The oil O then travels along the oil channel 626 and enters the second oil chamber 34 through the first guide hole 642 of the first oil guide member 64. Thereafter, reopen the control valve 56 and release the inner tube 30. At this point, the inner tube 30 will automatically rise until the second oil guide member 65 rests against the floating piston 63 (as shown in FIG. 6). This completes the restoration of the original upward stroke of the inner tube 30.

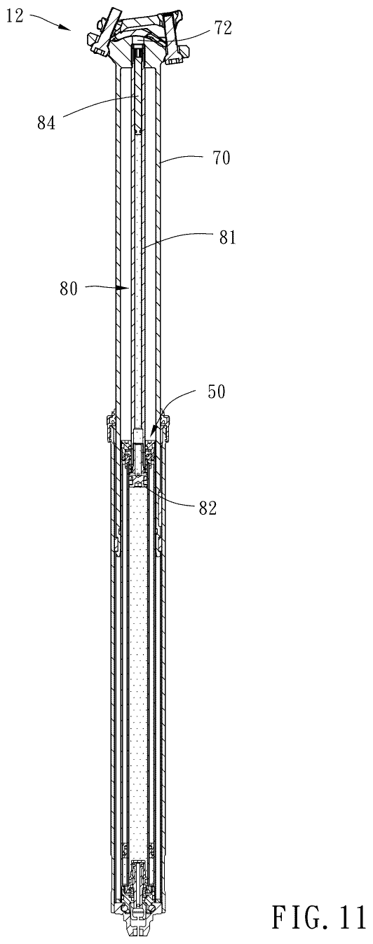

Please refer to FIG. 11, the main structure of the dropper seatpost 12 of the second embodiment is approximately the same with the first embodiment, but one of the differences therebetween is that the inner tube 70 omits the first oil chamber 33 and the second oil chamber 34, and the stroke adjustment assembly 80 uses an adjustment screw 84 to control the oil volume.

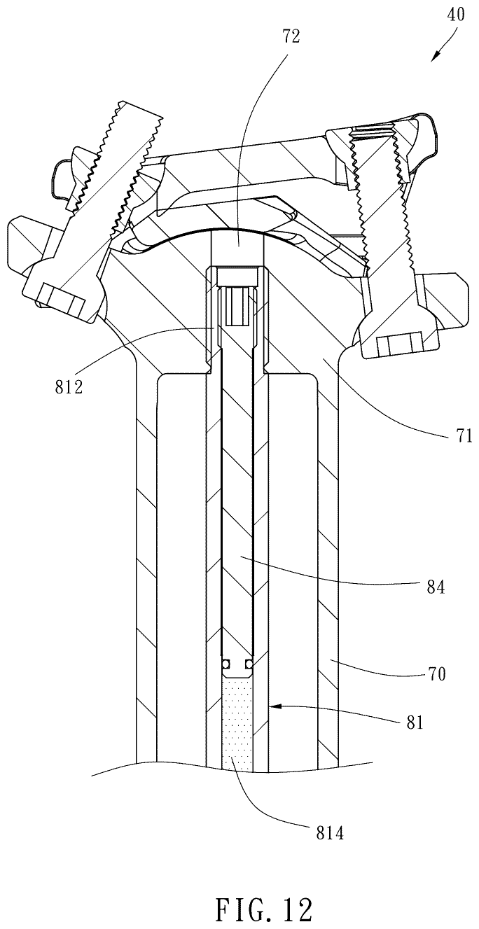

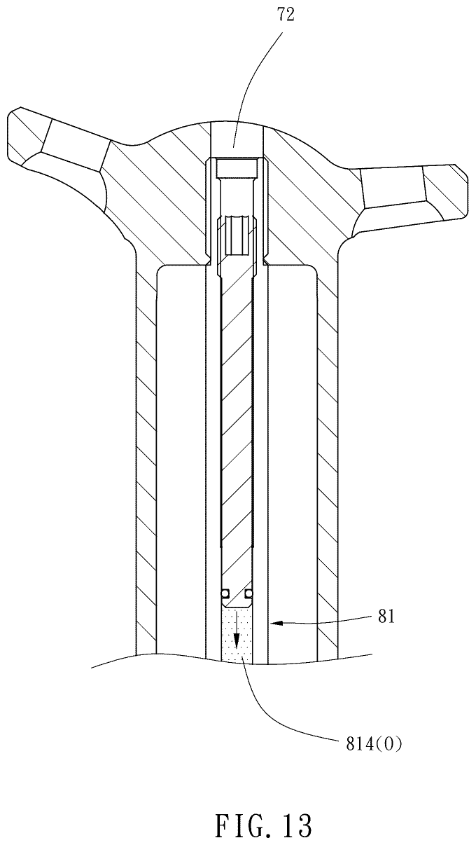

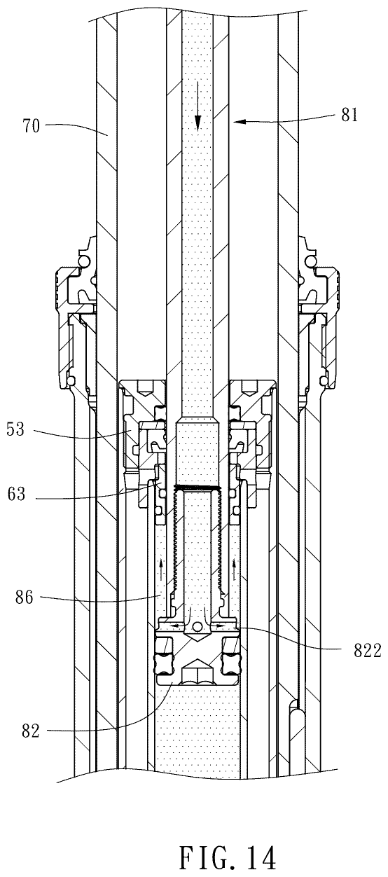

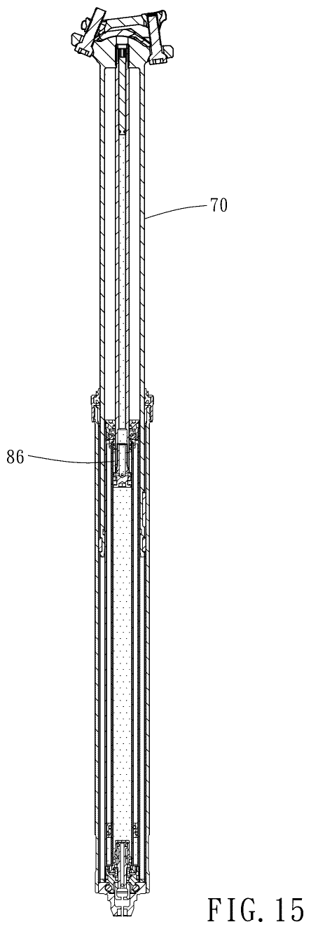

In this embodiment, as shown in FIG. 12, the inner tube 70 includes an adjustment hole 72 axially passing through the top end 71. Further, the stroke adjustment assembly 80 includes an adjustment screw 84 penetrated through the adjustment hole 72 and screwed to the first guide end 812 of the oil guide pipe 81. When reducing the maximum upward stroke of the inner tube 70, first detach the saddle clamping device 40, then open the control valve 56 (as shown in FIG. 7) and press down the inner tube 70 to exceed its adjustable stroke, then close the control valve 56, temporarily positioning the inner tube 70. Next, use a tool (such a screwdriver, not shown) to rotate the adjustment screw 84 through the adjustment hole 72 (as shown in FIG. 13), causing adjustment screw 84 to push the oil O in the oil channel 814 to flow through the second guide holes 822 of the second oil guide member 82 into the third chamber 86 (as shown in FIG. 14). Thereafter, reopen the control valve 56 and release the inner tube 70. At this point, the inner tube 70 will automatically rise. During the upward movement, the oil O in the third oil chamber 66 pushes the floating piston 63 upward until the floating piston 63 comes into contact with the top cover 53, at which point the upward movement will stop. In this way, as shown in FIG. 15, the inner tube 70 is restricted by the third oil chamber 86 to complete the reduction of the maximum upward stroke.

Conversely, to restore the original upward stroke, first open the pneumatic and hydraulic cylinder 50 and press down the inner tube 70 to exceed its adjustable stroke, then close the pneumatic and hydraulic cylinder 50, temporarily positioning the inner tube 70. Next, rotate the adjustment screw 84 upward, allowing the oil O in the third oil chamber 86 to flow through the second guide holes 822 of the second oil guide member 82 into the oil channel 814 of the oil guide pipe 81. Thereafter, reopen the control valve 56 and release the inner tube 70. At this point, the inner tube 70 will automatically rise until the second oil guide member 82 rests against the floating piston 63. This completes the restoration of the original upward stroke of the inner tube 70.

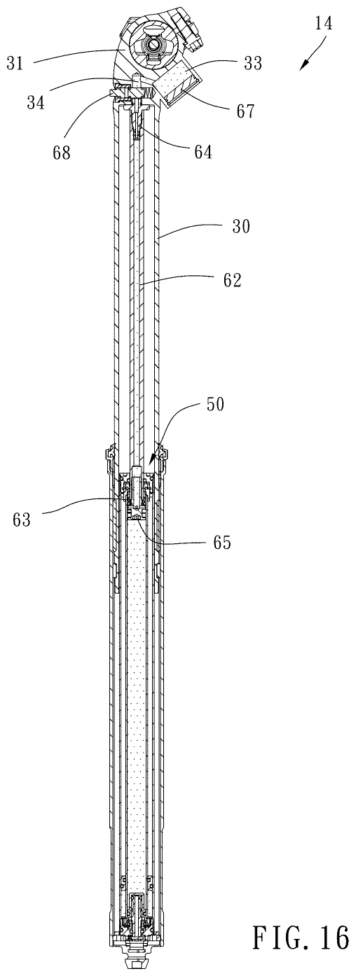

Please refer to FIG. 16, the main structure of the dropper seatpost 14 of the third embodiment is approximately the same with the first embodiment, but one of the differences therebetween is that the stroke adjustment assembly 60 uses a piston 67 to replace the knob 61, and uses a button 68 to control the oil O.

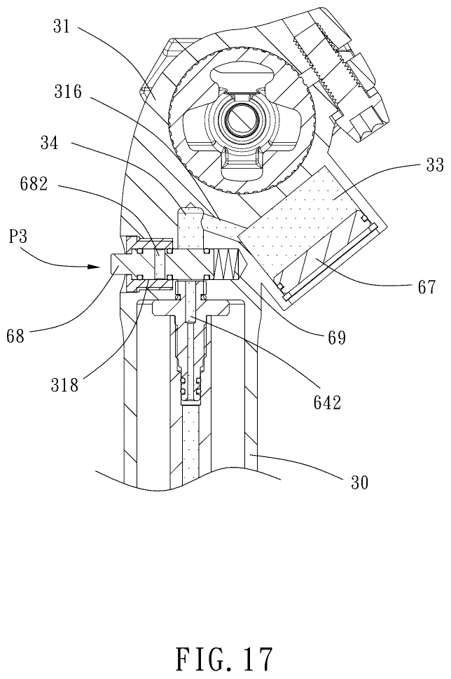

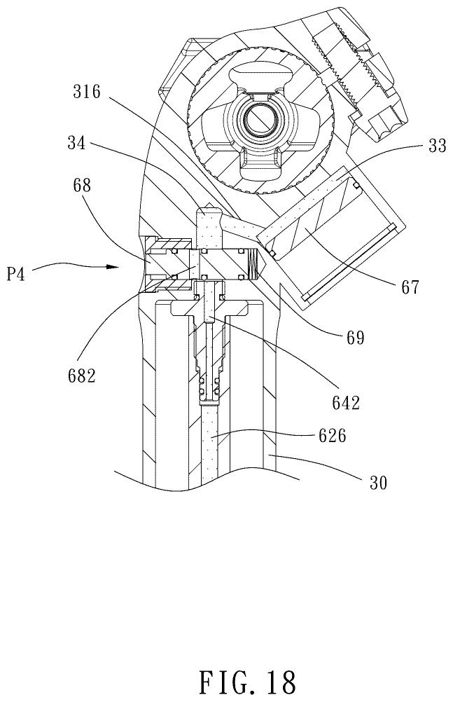

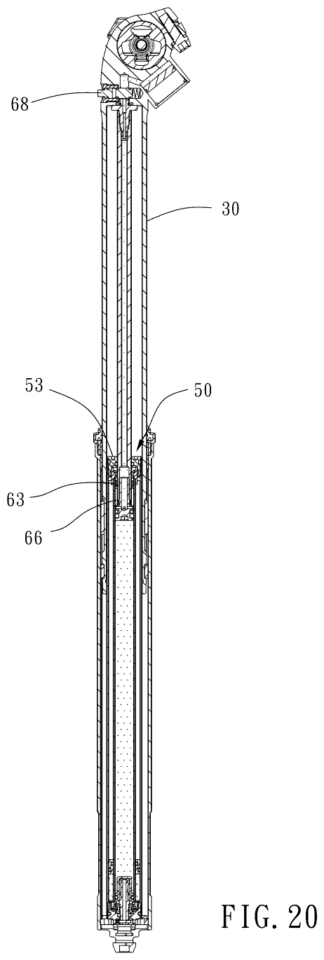

In this embodiment, as shown in FIG. 17, the top end 31 of the inner tube 30 further includes a button hole 318 radially communicating with the second oil chamber 34 and the first guide hole 642. When the button 68 is located an initial position P3 as shown in FIG. 17 under an elastic force generated by a return elastic member 69, the second oil chamber 34 and the first guide hole 642 is blocked by the button 68, so that they do not communicate with each other. When the button 68 is located at a pressed position P4 as shown in FIG. 18, the second oil chamber 34 and the first guide hole 642 communicate with each other through a communicate hole 682 of the button 68. As such, when reducing the maximum upward stroke of the inner tube 30, first open the control valve 56 (as shown in FIG. 7) and press down the inner tube 30 to exceed its adjustable stroke, then close the control valve 56, temporarily positioning the inner tube 30. Next, press the button 68 to the pressed position P4 and push the piston 67 inward, causing the oil O in the first oil chamber 33 to flow through the passage 316 into the second oil chamber 34. Then, the oil O flows from the second oil chamber 34 through the communicate hole 682 of the button 68 and the first guide hole 642 of the first oil guide member 64 into the oil channel 626 of the oil guide pipe 62 (as shown in FIG. 18). The oil O then flows through the oil channel 626 into the second guide holes 652 of the second oil guide member 65, and finally flows from the second guide holes 652 of the second oil guide member 65 into the third oil chamber 66 formed between the second guide end 624 of the oil guide pipe 62 and the floating piston 63 (as shown in FIG. 9). Thereafter, release the button 68 and reopen the control valve 56 and release the inner tube 30. At this point, the inner tube 30 will automatically rise. During the upward movement of the inner tube 30, the oil O in the third oil chamber 66 pushes the floating piston 63 upward until the floating piston 63 comes into contact with the top cover 53, at which point the upward movement will stop. In this way, as shown in FIG. 20, the inner tube 30 is restricted by the third oil chamber 66 to complete the reduction of the maximum upward stroke.

Conversely, to restore the original upward stroke, first open the control valve 56 and press down the inner tube 30 to exceed its adjustable stroke, then close the control valve 56. Next, press the button 68 to the pressed position P4, allowing the oil O in the third oil chamber 66 to flow through the second guide holes 652 of the second oil guide member 65 into the oil channel 626 of the oil guide pipe 62. The oil O then travels along the oil channel 626 and enters the second oil chamber 34 from the first guide hole 642 of the first oil guide member 64 through the communicate hole 682. Finally, the oil O flows from the second oil chamber 34 into the first oil chamber 33 and pushes the piston 67 outward. Thereafter, release the button 68 and reopen the control valve 56 and release the inner tube 30. At this point, the inner tube 30 will automatically rise until the second oil guide member 65 rests against the floating piston 63 (as shown in FIG. 16). This completes the restoration of the original upward stroke of the inner tube 30.

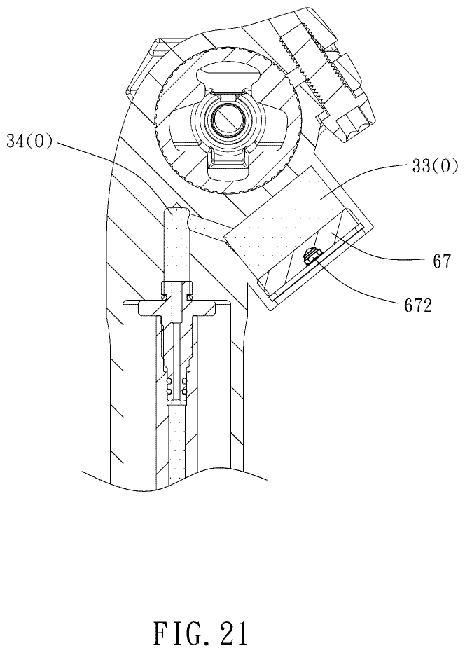

It should be supplemented here that in the aforesaid embodiment, the piston 67 can also be configured by screwing, and a hexagonal hole 672 for engaging a tool (such as a hex wrench, not shown) is provided on the piston 67, as shown in FIG. 21. This allows the piston 67 to push the oil O in the first oil chamber 33 or release space from the first oil chamber 33 when driven by the aforementioned tool, thus allowing the oil O from the second oil chamber 34 to flow back. In this case, the button 68 can be omitted. As for adjusting the maximum upward stroke of the inner tube 30, it is the same as in the aforementioned embodiment, and thus will not be elaborated here.

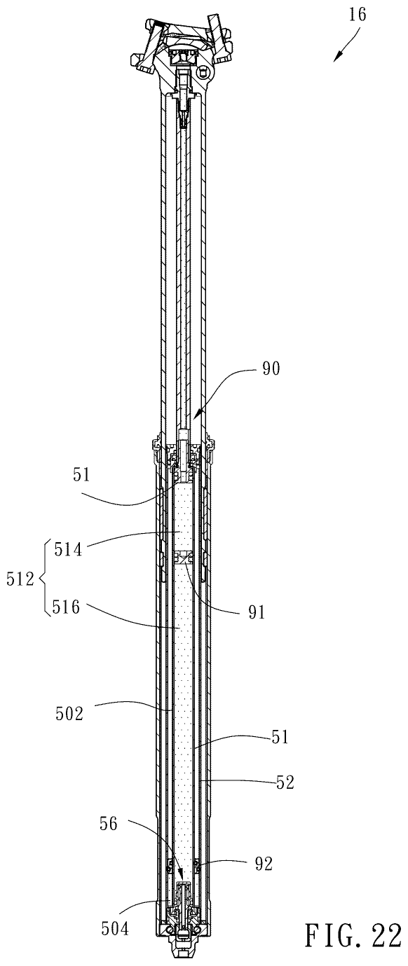

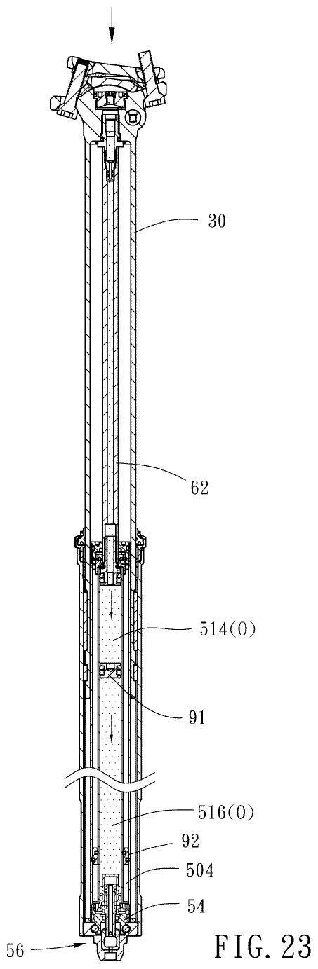

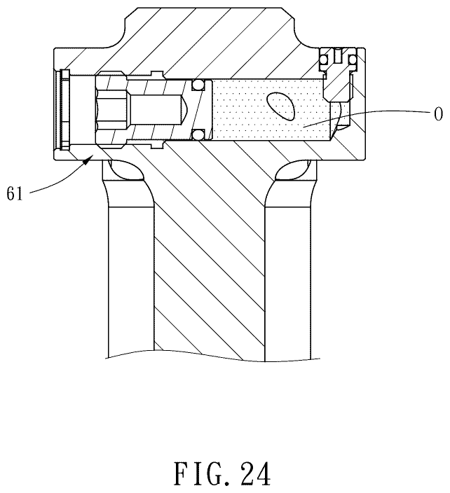

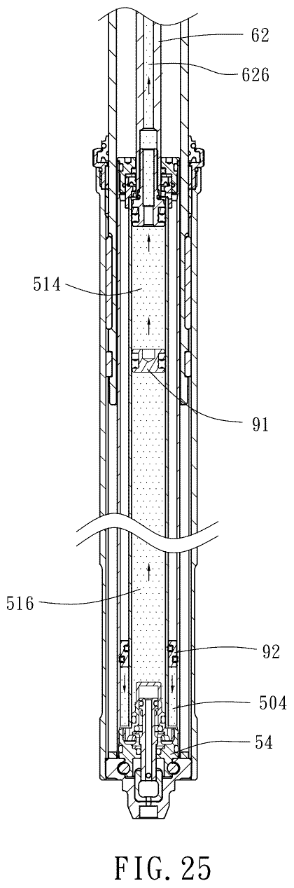

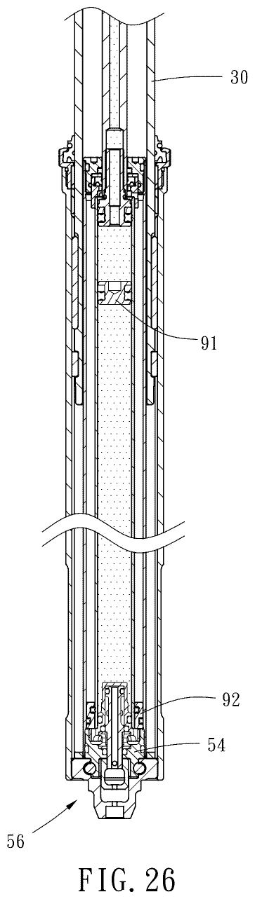

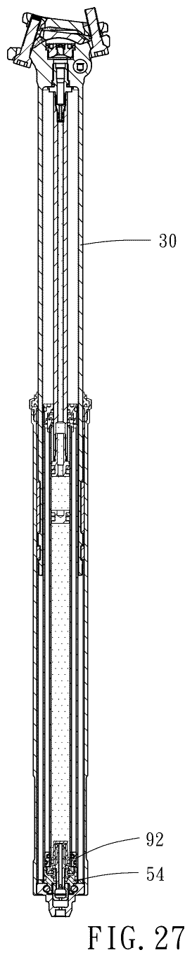

Please refer to FIG. 22, the main structure of the dropper seatpost 16 of the fourth embodiment is approximately the same with the first embodiment, but one of the differences therebetween is that the stroke adjustment assembly 90 has different structure. In this embodiment, the stroke adjustment assembly 90 includes two floating pistons 91, 92. The floating piston 91 is disposed in the inner cylinder 512 and located between the second oil guide member 65 and the control valve 56 so as to divide the inner oil chamber 512 into an upper oil area 514 and a lower oil area 516. The floating piston 92 is disposed between the inner and outer cylinders 51, 52 to separate the air chamber 502 and the outer oil chamber 504. When reducing the maximum upward stroke of the inner tube 30, first open the control valve 56 (as shown in FIG. 23) and press down the inner tube 30 to exceed its adjustable stroke. During the downward movement of the inner tube 30, the oil guide pipe 62 presses the floating piston 91 through the oil O in the upper oil area 514, and the floating piston 91 pushes the oil O in the lower oil area 516 into the outer oil chamber 504 through the control valve 56, causing the floating piston 92 to move toward a direction away the bottom cover 54. Then, rotate the knob 61 outward (as shown in FIG. 24), causing the oil O in the upper oil area 514 to flow into the guide channel 626, as shown in FIGS. 25 and 26. At this point, the floating piston 91 is moved toward the oil guide tube 62 due to the decrease in the oil volume in the upper oil area 514; meanwhile, the oil O in the outer oil chamber 504 flows back into the lower oil area 516 through the control valve 56, causing the floating piston 92 to move toward the bottom cover 54 due to the decrease in the oil volume in the outer oil chamber 504. The floating piston 92 continues moving until it contacts the bottom cover 54, at which point the control valve 56 is closed. In this way, as shown in FIG. 27, the inner tube 30 is restricted by the floating piston 92 to complete the reduction of the maximum upward stroke.

It should be added here that the floating piston 91 can be omitted according to actual needs. In this case, by directly pressing down the oil O in the inner oil chamber 512 through the oil guide pipe 62, the floating piston 92 rises and then the oil O is extracted from the inner oil chamber 512, causing the floating piston 92 to move downward until it contacts the bottom cover 54. This allows for the adjustment of the maximum upward stroke of the inner tube 30.

As indicated above, the dropper seatpost 10, 12, 14, 16 of the present invention utilizes the stroke adjustment assembly 60, 80, 90 in conjunction with the oil O to adjust the maximum upward stroke of the inner tube 30, 70. Once the adjustment is completed, there is no need to readjust the saddle height for the same rider, thus effectively saving operation time and enhancing user convenience.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A dropper seatpost comprising:
an outer tube;
an inner tube disposed movably upward and downward in the outer tube, the inner tube having a top end located outside the outer tube and a bottom end located inside the outer tube;
a pneumatic and hydraulic cylinder disposed in the outer tube for controlling a vertical movement of the inner tube relative to the outer tube, so that when the pneumatic and hydraulic cylinder is opened, the inner tube is allowed to be moved upward and downward relative to the outer tube, and when the pneumatic and hydraulic cylinder is closed, the inner tube is unable to be moved upward and downward relative to the outer tube; and
a stroke adjustment assembly including a floating piston movably disposed in the pneumatic and hydraulic cylinder, and an oil guide pipe mounted in the inner tube and having a first guide end mounted to the top end of the inner tube, a second guide end inserted into the pneumatic and hydraulic cylinder, and a guide channel located between the first and second guide ends, wherein when the pneumatic and hydraulic cylinder is closed, and an oil is output from the second guide end of the oil guide pipe or flows back into the oil guide pipe from the second guide end, the floating piston is moved according to an oil volume, thereby adjusting a maximum upward stroke of the inner tube.

2. The dropper seatpost as claimed in claim 1, wherein the pneumatic and hydraulic cylinder includes an outer cylinder, an inner cylinder disposed in the outer cylinder and spaced from the outer cylinder, and a top cover mounted on top ends of the inner and outer cylinders; the second guide end of the oil guide pipe is penetrated through the top cover and located inside the inner cylinder; the floating piston is disposed between the top cover and the second guide end of the oil guide pipe; when the pneumatic and hydraulic cylinder is closed and the oil is output from the second guide end of the oil guide pipe, the floating piston is moved toward a direction away from the second guide end of the oil guide pipe, and when the pneumatic and hydraulic cylinder is closed and the oil flows back into the oil guide pipe from the second oil end, the floating piston is moved toward the second guide end of the oil guide pipe.

3. The dropper seatpost as claimed in claim 2, wherein the top end of the inner tube has a first oil chamber and a second oil chamber communicating with the first oil chamber and axially communicating with the first guide end of the oil guide pipe.

4. The dropper seatpost as claimed in claim 3, wherein the top end of the inner tube has an adjustment threaded hole communicating with the first oil chamber; the stroke adjustment assembly further includes a knob screwed to the adjustment threaded hole for pushing the oil in the first oil chamber to the second oil chamber or allowing the oil in the second oil chamber to flow back into the first oil chamber.

5. The dropper seatpost as claimed in claim 4, wherein the inner cylinder has an inner oil chamber; an air chamber is formed between the top cover, the inner cylinder, and the outer cylinder; the pneumatic and hydraulic cylinder further includes a bottom cover mounted to bottom ends of the inner and outer cylinders and forming an outer oil chamber located below the air chamber with the inner and outer cylinders, and a control valve disposed in the inner cylinder and operable between an open position where the inner and outer oil chambers communicate with each other and a close position where the inner and outer oil chambers do not communicate with each other.

6. The dropper seatpost as claimed in claim 2, wherein the inner tube has an adjustment hole axially passing through the top end; the first guide end of the oil guide pipe is screwed to the adjustment hole; the stroke adjustment assembly further includes an adjustment screw disposed in the guide channel and screwed to the first guide end of the oil guide pipe for pushing the oil from the oil channel to the second guide end or allowing the oil to flow from the second guide end into the guide channel.

7. The dropper seatpost as claimed in claim 6, wherein the inner cylinder has an inner oil chamber; an air chamber is formed between the top cover, the inner cylinder, and the outer cylinder; the pneumatic and hydraulic cylinder further includes a bottom cover mounted to bottom ends of the inner and outer cylinders and forming an outer oil chamber located below the air chamber with the inner and outer cylinders, and a control valve disposed in the inner cylinder and operable between an open position where the inner and outer oil chambers communicate with each other and a close position where the inner and outer oil chambers do not communicate with each other.

8. A dropper seatpost comprising:
an outer tube;
an inner tube disposed movably upward and downward in the outer tube, the inner tube having a top end located outside the outer tube and a bottom end located inside the outer tube;
a pneumatic and hydraulic cylinder disposed in the outer tube for controlling a vertical movement of the inner tube relative to the outer tube, so that when the pneumatic and hydraulic cylinder is opened, the inner tube is allowed to be moved upward and downward relative to the outer tube, and when the pneumatic and hydraulic cylinder is closed, the inner tube is unable to be moved upward and downward relative to the outer tube; and
a stroke adjustment assembly including a floating piston movably disposed in the pneumatic and hydraulic cylinder, and an oil guide pipe mounted in the inner tube and having a first guide end mounted to the top end of the inner tube, a second guide end inserted into the pneumatic and hydraulic cylinder, and an guide channel located between the first and second guide ends, wherein when an oil is output from the second guide end of the oil guide pipe or flows back into the oil guide pipe from the second oil end, the floating piston is moved according to an oil volume, thereby adjusting a maximum upward stroke of the inner tube;
wherein the pneumatic and hydraulic cylinder includes an outer cylinder, an inner cylinder having an inner oil chamber and disposed in the outer cylinder and spaced from the outer cylinder, a top cover mounted on top ends of the inner and outer cylinders and forming an air chamber with the inner and outer cylinders, a bottom cover mounted to bottom ends of the inner and outer cylinders and forming an outer oil chamber located below the air chamber with the inner and outer cylinders, and a control valve disposed in the inner cylinder and operable between an open position where the inner and outer oil chambers communicate with each other and a close position where the inner and outer oil chambers do not communicate with each other;
wherein the second guide end of the oil guide pipe is penetrated through the top cover and located inside the inner cylinder;
wherein the floating piston is disposed between the inner and outer cylinders and separating the air chamber and the outer oil chamber;
wherein when the control valve is located at the open position and the oil is output from the second guide end of the oil guide pipe, the floating piston is moved toward a direction away from the bottom cover, and when the control valve is opened and the oil flows back into the oil guide pipe from the second oil end, the floating piston is moved toward the bottom cover.

9. The dropper seatpost as claimed in claim 8, wherein the stroke adjustment assembly includes two said floating pistons; one of the floating pistons is disposed in the inner oil chamber and located between the second guide end of the oil guide pipe and the control valve to divide the inner oil chamber into an upper oil area and a lower oil area; the other of the floating pistons is disposed between the inner and outer cylinders and separating the air chamber and the outer oil chamber; when the control valve is opened and the oil flows back into the oil guide pipe from the second oil end, the floating piston in the inner oil chamber is moved toward the oil guide pipe and the floating piston between the inner and outer cylinders is moved toward the bottom cover.

10. The dropper seatpost as claimed in claim 2, wherein the top end of the inner tube has a first oil chamber, a second oil chamber communicating with the first oil chamber, and a button hole communicating with the second oil chamber and the first guide end of the oil guide pipe; the stroke adjustment assembly further includes a piston movably disposed in the first oil chamber for pushing the oil in the first oil chamber into the second oil chamber or allowing the oil in the second oil chamber to flow back into the first oil chamber, a button movably disposed in the button hole and movable between an initial position where the second oil chamber and the first guide end of the oil guide pipe do not communicate with each other by obstruction of the button and a pressed position where the second oil chamber and the first guide end of the oil guide pipe communicate with each other through a communication hole of the button, and a return elastic member acting on the button to keep the button in the initial position.

11. The dropper seatpost as claimed in claim 10, wherein the inner cylinder has an inner oil chamber; an air chamber is formed between the top cover, the inner cylinder, and the outer cylinder; the pneumatic and hydraulic cylinder further includes a bottom cover mounted to bottom ends of the inner and outer cylinders and forming an outer oil chamber located below the air chamber with the inner and outer cylinders, and a control valve disposed in the inner cylinder and operable between an open position where the inner and outer oil chambers communicate with each other and a close position where the inner and outer oil chambers do not communicate with each other.
